(19) United States
(12) Patent Application Publication
(10) Pub. No.: US 2026/0300342 A1
(43) Pub. Date: Oct. 1, 2026

(54) INFORMATION PROCESSING APPARATUS, INFORMATION PROCESSING METHOD, AND NON-TRANSITORY COMPUTER-READABLE STORAGE MEDIUM

(71) Applicant: CANON KABUSHIKI KAISHA, Tokyo (JP)

(72) Inventors: Shimpei FUJISAKI, Tokyo (JP); Tomoaki HIGO, Kanagawa (JP)

(21) Appl. No.: 19/632,511

(22) Filed: Mar. 30, 2026

(30) Foreign Application Priority Data
Apr. 1, 2025 (JP) 2025-060707

(51) Int. Cl. G06F 16/3329; G06F 40/242

(52) U.S. Cl. CPC G06F 16/33295; G06F 40/242

(57) ABSTRACT

An information processing apparatus comprises an acquisition unit configured to acquire, based on an input question, text information regarding an answer to the question using a large language model, a decision unit configured to decide, based on the text information, whether to present non-text information, and a transmission unit configured to transmit the text information and the non-text information in a case where it is decided to present the non-text information, and transmit the text information in a case where it is decided not to present the non-text information.

### BACKGROUND

### Field of the Technology

The present disclosure relates to a technique for presenting an answer to a question.

### Description of the Related Art

There is conventionally known a technique of generating an answer sentence by inputting, to a large language model, a prompt created based on a question of a user and a document related to the question, and presenting the answer sentence to the user (for example, Japanese Patent No. 7538364).

However, in the conventional technique, if important information as an answer cannot be expressed only by a character string, only the presented answer sentence is insufficient for the user to determine whether it is an appropriate answer, and much labor may be required to investigate additional information for determination.

### SUMMARY

The present disclosure provides a technique for presenting an appropriate answer to a question.

According to the first aspect of the present disclosure, there is provided an information processing apparatus comprising: an acquisition unit configured to acquire, based on an input question, text information regarding an answer to the question using a large language model; a decision unit configured to decide, based on the text information, whether to present non-text information; and a transmission unit configured to transmit the text information and the non-text information in a case where it is decided to present the non-text information, and transmit the text information in a case where it is decided not to present the non-text information.

Features of the present disclosure will become apparent from the following description of embodiments with reference to the attached drawings. The following description of embodiments is described by way of example.

### BRIEF DESCRIPTION OF THE DRAWINGS

The accompanying drawings, which are incorporated in and constitute a part of the specification, illustrate embodiments of the present disclosure, and together with the description, serve to explain the principles of the embodiments.

FIG. 1 is a view showing a use case of a system;

FIG. 2A is a block diagram showing an example of the hardware configuration of a tablet 3;

FIG. 2B is a block diagram showing an example of the hardware configuration of a question answering system 4;

FIG. 3 is a block diagram showing an example of the functional configuration of each of the tablet 3 and the question answering system 4;

FIG. 4 is a flowchart of processing performed by the tablet 3 and the question answering system 4 to create an answer to a question input by a user and present it to the user;

FIG. 5A is a view showing a display example of a screen;

FIG. 5B is a view showing a display example of the screen;

FIG. 6 is a flowchart illustrating details of processing in step S404;

FIG. 7A is a view showing a display example of a screen;

FIG. 7B is a view showing a display example of a screen;

FIG. 8 is a view showing a display example of a screen;

FIG. 9A is a view showing a display example of a screen;

FIG. 9B is a view showing a display example of a screen;

FIG. 10A is a view showing a display example of a screen; and

FIG. 10B is a view showing a display example of a screen.

### DESCRIPTION OF THE EMBODIMENTS

Hereinafter, embodiments will be described in detail with reference to the attached drawings. Note, the following embodiments are not intended to limit the scope of the claims. Multiple features are described in the embodiments, but it is not the case that all such features are required, and multiple such features may be combined as appropriate. Furthermore, in the attached drawings, the same reference numerals are given to the same or similar configurations, and redundant description thereof is omitted.

### First Embodiment

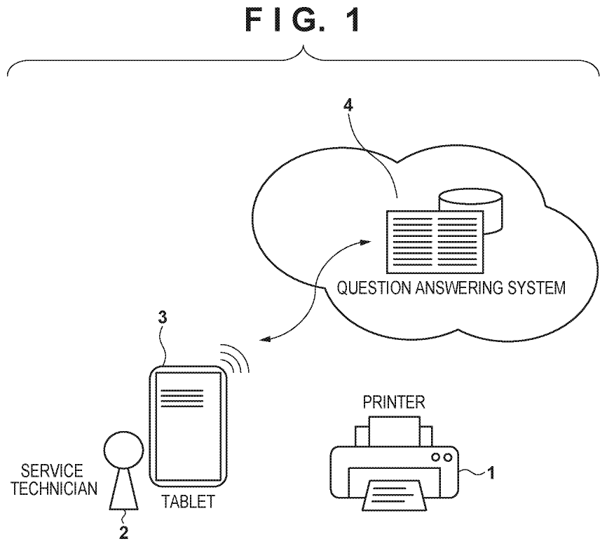

A use case of a system according to this embodiment will be described first with reference to FIG. 1. In the use scene shown in FIG. 1, a problem has occurred in a printer 1. The problem that has occurred in the printer 1 is, for example, an image defect such as a stain at a leading edge of a printed image. To solve this problem, a service technician 2 (user) called to repair the printer 1 looks for a solution using a tablet 3 as an example of an information processing apparatus. First, the service technician 2 inputs a question by operating the tablet 3. After the end of the input of the question, the service technician 2 instructs to transmit the question. When transmission of the question is instructed, the tablet 3 transmits the input question to a question answering system 4 via a wireless network. The question answering system 4 creates an answer corresponding to the question received from the tablet 3, and transmits the created answer to the tablet 3. Upon receiving the answer transmitted from the question answering system 4, the tablet 3 presents the received answer to the service technician 2. The service technician 2 specifies the solution of the problem of the printer 1 based on the presented answer.

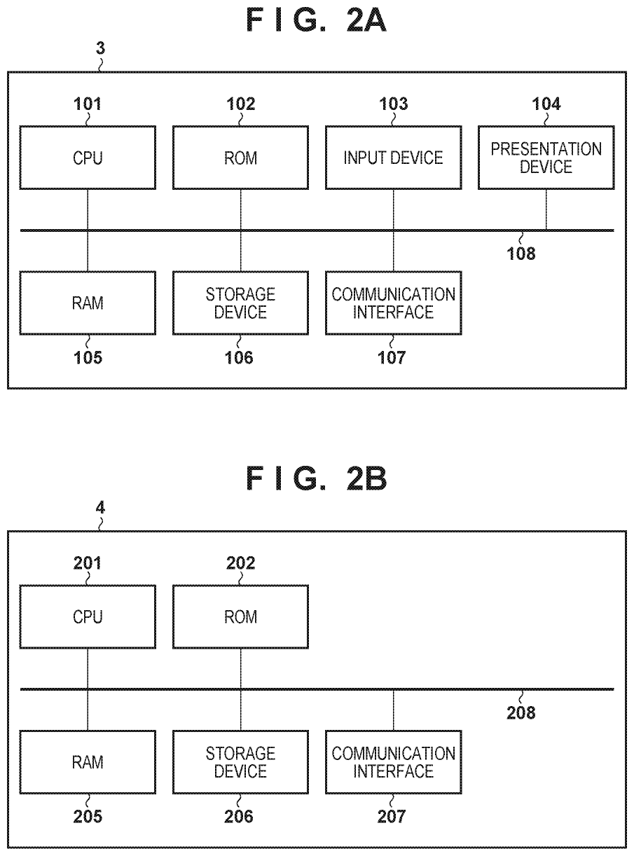

Next, an example of the hardware configuration of the tablet 3 will be described with reference to the block diagram of FIG. 2A. Note that the example of the hardware configuration shown in FIG. 2A is an example of a hardware configuration applicable to the tablet 3, and can be modified/changed appropriately.

A CPU 101 executes various kinds of processing using computer programs and data stored in a RAM 105. Thus, the CPU 101 controls the operation of the entire tablet 3, and also executes or controls various kinds of processing described as processing executed by the tablet 3.

A ROM 102 stores setting data of the tablet 3, a computer program and data associated with activation of the tablet 3, a computer program and data associated with the basic operation of the tablet 3, and the like.

An input device 103 is a user interface such as a keyboard, a mouse, or a touch panel, and a user can input various kinds of instructions and information to the tablet 3 by operating the input device 103.

A presentation device 104 is an interface for presenting the result of processing by the tablet 3 to the user. For example, the presentation device 104 includes a liquid crystal screen or a touch panel screen, and can display the result of processing by the CPU 101 as an image or characters. Furthermore, for example, the presentation device 104 includes a loudspeaker, and can output the result of processing by the CPU 101 as sound.

The RAM 105 includes an area used to store computer programs and data loaded from the ROM 102 or a storage device 106, and an area used to store computer programs and data received from an external apparatus via a communication interface 107. The RAM 105 also includes a work area used by the CPU 101 when executing various kinds of processing. The RAM 105 can thus appropriately provide various kinds of areas.

The storage device 106 is a nonvolatile memory device such as a Solid State Drive (SSD) and a Hard Disk Drive (HDD). The storage device 106 stores an OS, computer programs and data used to cause the CPU 101 to execute or control various kinds of processing described as processing executed by the tablet 3, and the like.

The communication interface 107 is an interface used by the tablet 3 to perform data communication with an external apparatus via a network such as a LAN or the Internet. The network may be a wired network or a wireless network. The type of the network is not limited to a specific one such as USB or serial communication.

All of the CPU 101, the ROM 102, the input device 103, the presentation device 104, the RAM 105, the storage device 106, and the communication interface 107 are connected to a system bus 108.

An example of the hardware configuration of the question answering system 4 will be described next with reference to the block diagram of FIG. 2B. Note that a case where the question answering system 4 is implemented by a single computer apparatus will be described below. However, the present disclosure is not limited to this, and the question answering system 4 may be implemented using a plurality of computer apparatuses. The example of the hardware configuration shown in FIG. 2B is an example of a hardware configuration applicable to the question answering system 4, and can be modified/changed appropriately.

A CPU 201 executes various kinds of processing using computer programs and data stored in a RAM 205. Thus, the CPU 201 controls the operation of the entire question answering system 4, and also executes or controls various kinds of processing described as processing executed by the question answering system 4.

A ROM 202 stores setting data of the question answering system 4, a computer program and data associated with activation of the question answering system 4, a computer program and data associated with the basic operation of the question answering system 4, and the like.

The RAM 205 includes an area used to store computer programs and data loaded from the ROM 202 or a storage device 206, and an area used to store computer programs and data received from an external apparatus via a communication interface 207. The RAM 205 also includes a work area used by the CPU 201 when executing various kinds of processing. The RAM 205 can thus appropriately provide various kinds of areas.

The storage device 206 is a nonvolatile memory device such as a Solid State Drive (SSD) and a Hard Disk Drive (HDD). The storage device 206 stores an OS, computer programs and data used to cause the CPU 201 to execute or control various kinds of processing described as processing executed by the question answering system 4, and the like.

The communication interface 207 is an interface used by the question answering system 4 to perform data communication with an external apparatus via a network such as a LAN or the Internet. All of the CPU 201, the ROM 202, the RAM 205, the storage device 206, and the communication interface 207 are connected to a system bus 208.

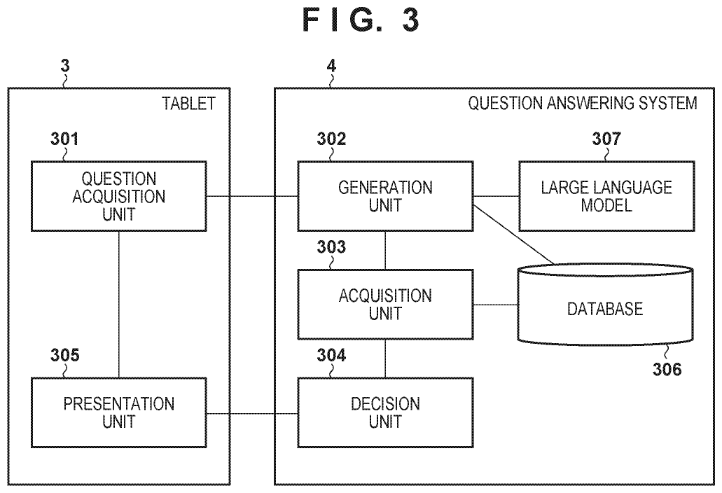

The block diagram of FIG. 3 shows an example of the functional configuration of each of the tablet 3 and the question answering system 4. This embodiment will describe a case where all of the function units of the tablet 3 shown in FIG. 3 are implemented by software (computer programs). Each function unit of the tablet 3 shown in FIG. 3 will sometimes be described below as the main constituent of processing, but the function of the function unit is actually implemented when the CPU 101 executes a computer program corresponding to the function unit. Similarly, this embodiment will describe a case where all of the function units of the question answering system 4 shown in FIG. 3 are implemented by software (computer programs). Each function unit of the question answering system 4 shown in FIG. 3 will sometimes be described below as the main constituent of processing, but the function of the function unit is actually implemented when the CPU 201 executes a computer program corresponding to the function unit.

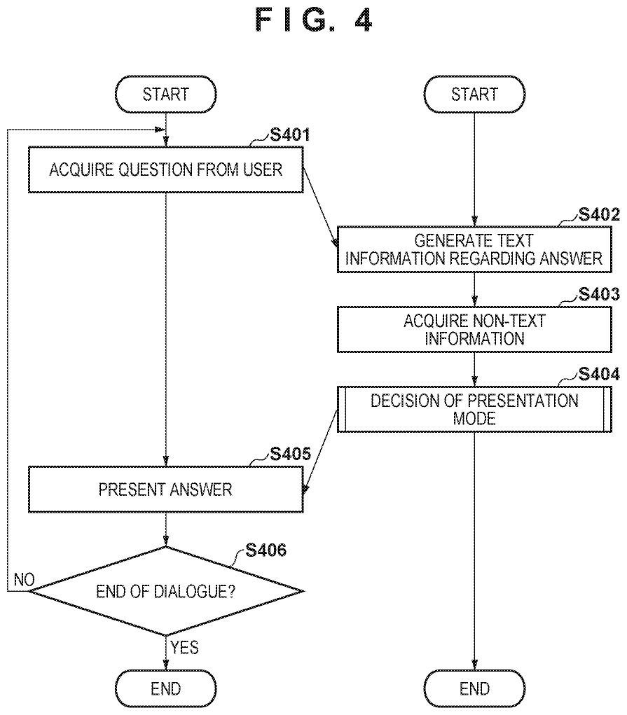

Processing performed by the tablet 3 and the question answering system 4 to create an answer to a question input by a user and present it to the user will be described with reference to a flowchart shown in FIG. 4.

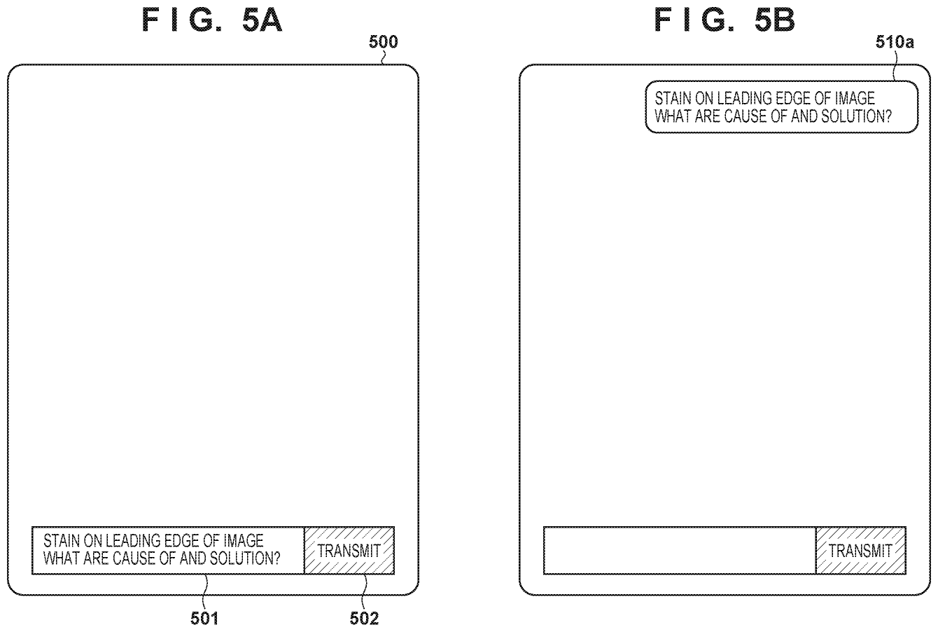

In step S401, a question acquisition unit 301 acquires a question input in accordance with a user operation. For example, the question acquisition unit 301 causes the presentation device 104 to display a screen 500 exemplified in FIG. 5A. The user inputs a question to an input box 501 using the input device 103. Upon completion of the input of the question, the user makes an instruction on a button 502 using the input device 103. When instruction is made on the button 502, the question acquisition unit 301 acquires the input question. Then, the question acquisition unit 301 causes the presentation device 104 to display the acquired question as a user-side chat bubble 510a, as exemplified in FIG. 5B. The question acquisition unit 301 transmits the acquired question to the question answering system 4 via the communication interface 107.

In step S402, a generation unit 302 acquires the question transmitted from the tablet 3. The generation unit 302 generates text information regarding an answer to the acquired question using a large language model 307 stored in the storage device 206. To generate text information regarding an answer to the acquired question, for example, a method described in P. Lewis et al., “Retrieval-Augmented Generation for Knowledge-Intensive NLP Tasks,” Advances in Neural Information Processing Systems, vol. 33, pp. 9459-9474, 2020 is applicable.

For example, the generation unit 302 searches for a source location (e.g., a URL) of a source document (for example, an HTML document) corresponding to the question in an “answer-related database 306” stored in the storage device 206 by using the acquired question as a query. Then, the generation unit 302 generates text information regarding an answer to the acquired question by inputting the acquired question and the source document identified by the source location found in the database 306 to the large language model 307 and performing inference using the large language model 307. Instead of inputting the entire source document to the large language model, only a relevant portion (source passage) of the source document, such as a sentence, paragraph, or chapter that matches a query by a character string search, can be input. By decreasing an information amount to a necessary one for the large language model to give an answer and inputting the information to the large language model, it is possible to reduce the waste of resources. The large language model 307 may be implemented using any suitable large language model configured to generate text information regarding an answer based on an input that includes at least the question and the source document (or the source passage). For example, the configuration may be achieved by prompting and/or by training such as fine-tuning, although training is not necessarily required.

In step S403, by using a dictionary registered in the database 306, an acquisition unit 303 acquires representative non-text information associated with a source passage (e.g., a sentence, paragraph, chapter) in the source document identified by the source location found in step S402. This embodiment will describe a case where the non-text information is an image.

The dictionary is information representing the relationship between the source location in the database 306 and corresponding representative non-text information. The dictionary is, for example, a JSON file in which the source location and the address of the corresponding non-text information in the database 306 are described in a key-value format, and is stored in the database 306. The “representative non-text information” corresponding to the source location is, for example, non-text information with a high semantic similarity to the title of the source document identified by the source location among pieces of non-text information associated with the source location (for example, pieces of non-text information linked in the source document (HTML document)). The dictionary is created in advance and registered in the database 306. In the database, knowledge information (information unlikely to have been included in training data of the large language model) concerning a product, such as a manual of a printer product, can be registered as a dictionary.

A dictionary may be created manually in accordance with a user operation or may be created in the apparatus. When creating a dictionary in the apparatus, for example, the apparatus acquires the embedding of the title and the embedding of non-text information using a shared embedding space (cross-modal embedding) model for natural language and non-text information. Then, the apparatus obtains, as the above-described similarity, the cosine similarity between the acquired embeddings.

In step S404, a decision unit 304 decides the presentation mode of the answer to the question. In this embodiment, the decision unit 304 decides the presentation mode of the answer to the question of the user including the presentation mode of the non-text information from the viewpoint of whether the user readily understands the contents of the answer to be presented in subsequent processing. Details of the processing in step S404 will be described later.

In step S405, a presentation unit 305 causes the presentation device 104 to present the answer to the question in accordance with the presentation mode decided by the decision unit 304. Details of the processing in step S405 will be described later.

In step S406, the CPU 101 determines whether a processing end condition is satisfied. Various conditions can be applied as the processing end condition. If, for example, the user inputs a processing end instruction using the input device 103, the CPU 101 determines that the processing end condition is satisfied.

As a result of the determination, if the processing end condition is satisfied, the processing according to the flowchart of FIG. 4 ends, and if the processing end condition is not satisfied, the process returns to step S401.

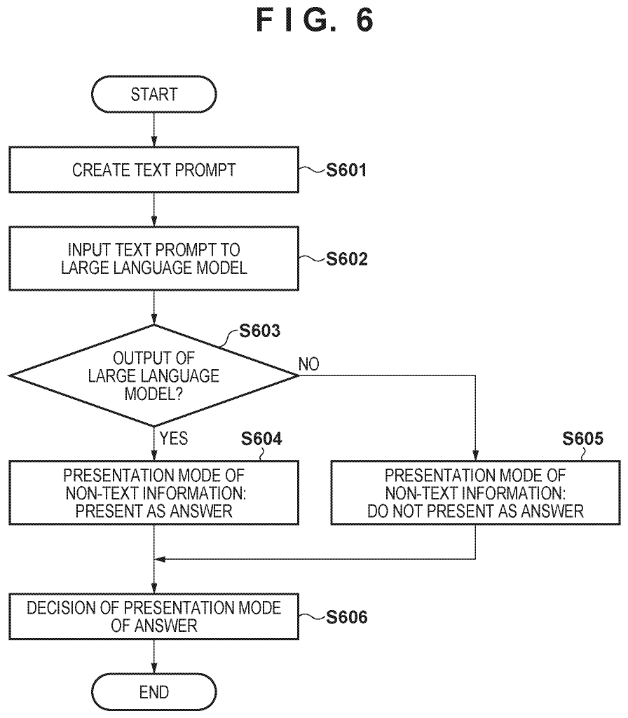

Details of the processing in step S404 will be described next with reference to a flowchart shown in FIG. 6. In step S601, the decision unit 304 creates a text prompt. More specifically, the decision unit 304 generates, as a text prompt, a character string by combining a preset template character string, the question transmitted from the tablet 3, and “the text information regarding the answer to the question” generated by the generation unit 302. As an example, a case where the template character string is “in the next question and answer, please answer Yes or No to indicate whether the appearance of an object is focused on” will be described below.

Note that the template character string is not limited to this. For example, the decision unit 304 may acquire a character string representing the non-text information acquired by the acquisition unit 303, and update the template character string by inserting the acquired character string into the template character string. For example, by setting, as the template character string, “in the next question and answer, please answer Yes or No to indicate whether the appearance of {non-text information} is focused on”, a portion corresponding to “{non-text information}” is replaced with “the character string representing the non-text information” acquired by the acquisition unit 303 and the template character string is then used. Note that as a method of acquiring the character string representing the non-text information, there may be provided a method of using alternative text associated with the non-text information in the HTML document identified by the source location and a method of using an image captioning model to generate a character string describing the image as the non-text information.

In step S602, the decision unit 304 inputs the text prompt generated in step S601 to the large language model 307 and performs inference using the large language model 307, thereby acquiring “Yes” or “No” as an answer corresponding to the text prompt. Note that to obtain the answer corresponding to the text prompt, the decision unit 304 may use a language model different from the large language model 307.

In step S603, the decision unit 304 determines whether the answer corresponding to the text prompt is “Yes” or “No”. As a result of the determination, if the answer corresponding to the text prompt is “Yes”, the process advances to step S604, and if the answer corresponding to the text prompt is “No”, the process advances to step S605.

In step S604, the decision unit 304 decides “to present the non-text information” as the presentation mode of the non-text information. In step S605, the decision unit 304 decides “not to present the non-text information” as the presentation mode of the non-text information.

In step S606, the decision unit 304 decides “the presentation mode of the answer” in accordance with the presentation mode of the non-text information decided in Step S604 or S605.

For example, if the decision unit 304 decides “to present the non-text information” as the presentation mode of the non-text information, it decides “to present an answer including the non-text information” as “the presentation mode of the answer”. On the other hand, if the decision unit 304 decides “not to present the non-text information” as the presentation mode of the non-text information, it decides “to present an answer without non-text information” as “the presentation mode of the answer”.

Then, if the decision unit 304 decides “to present an answer including the non-text information” as “the presentation mode of the answer”, it transmits the text information regarding the answer generated in step S402 and the non-text information acquired in step S403 to the tablet 3 via the communication interface 207.

On the other hand, if the decision unit 304 decides “to present an answer without non-text information” as “the presentation mode of the answer”, it transmits the text information regarding the answer generated in step S402 to the tablet 3 via the communication interface 207.

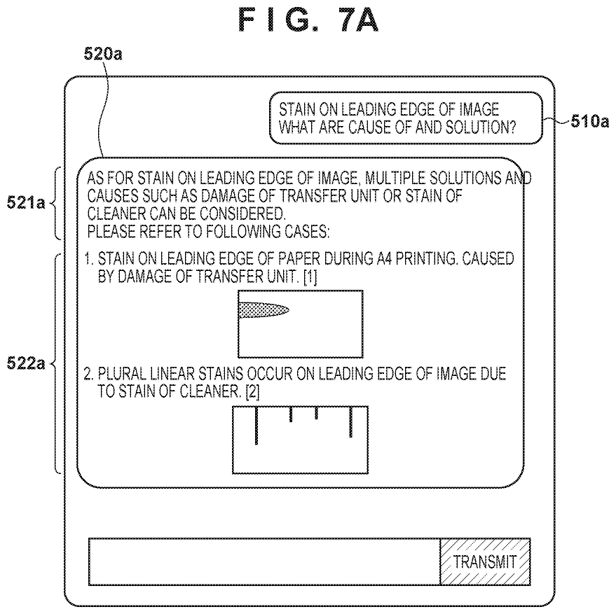

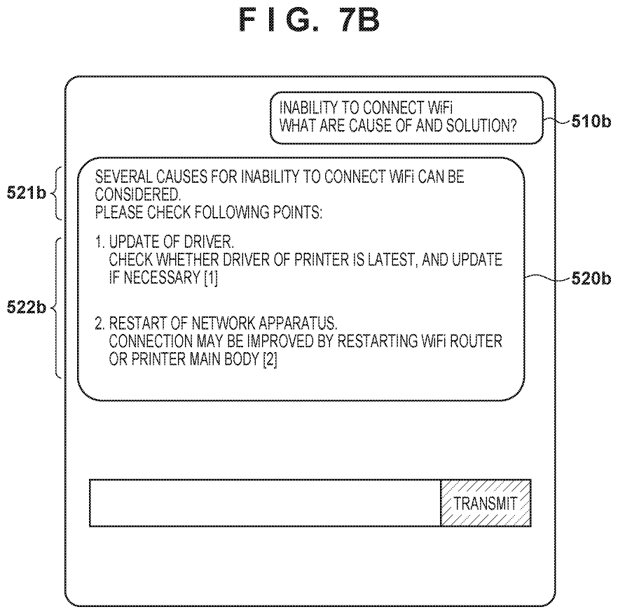

Next, the answer presented in accordance with the presentation mode decided by the decision unit 304 (the answer presented using the presentation device 104 by the presentation unit 305 in step S405) will be described with reference to FIGS. 7A and 7B.

FIG. 7A is a view showing a display example of an answer screen that is displayed on the presentation device 104 by the presentation unit 305 when the decision unit 304 decides “to present an answer including the non-text information” as “the presentation mode of the answer”.

In this case, the presentation unit 305 receives “the text information regarding the answer” and “the non-text information” transmitted from the question answering system 4, generates an answer screen including the received “text information regarding the answer” and “non-text information”, and causes the presentation device 104 to display the answer screen.

On the answer screen shown in FIG. 7A, the user-side chat bubble 510a representing a question input by a user and a system-side chat bubble 520a representing an answer to the question are displayed. The system-side chat bubble 520a includes a beginning portion 521a and an individual case portion 522a. Each individual case included in the individual case portion 522a includes a sentence related to source contents described in a source passage in the source document identified by the source location found in the database 306 by the generation unit 302 and corresponding non-text information. Text information and an image in the system-side chat bubble 520a correspond to “the text information regarding the answer” and “the non-text information”, respectively.

A character string “[1]” or “[2]” of the sentence end of each individual ca in the individual case portion 522a is linked to enable transition to the source location in the corresponding database 306. The user can know details of each individual case by selecting the link using the input device 103.

FIG. 7B is a view showing a display example of an answer screen that is displayed on the presentation device 104 by the presentation unit 305 when the decision unit 304 decides “to present an answer without non-text information” as “the presentation mode of the answer”.

In this case, the presentation unit 305 receives “the text information regarding the answer” transmitted from the question answering system 4, generates an answer screen including the received “text information regarding the answer”, and causes the presentation device 104 to display the answer screen.

On the answer screen shown in FIG. 7B, a user-side chat bubble 510b representing a question input by a user and a system-side chat bubble 520b representing an answer to the question are displayed. The system-side chat bubble 520b includes a beginning portion 521b and an individual case portion 522b. Each individual case included in the individual case portion 522b includes a sentence related to source contents described in the source document identified by the source location found in the database 306 by the generation unit 302 but includes no corresponding non-text information unlike FIG. 7A. Text information in the system-side chat bubble 520b corresponds to “the text information regarding the answer”.

As shown in FIG. 7A, if the question of the user and the answer to it focus on the appearance of the object and important information as the answer may not be represented only by a character string, the answer including an image as related non-text information is presented. Thus, the user can compare, with the image of each individual case in the answer, the appearance of an important target object (a print image with a stained leading edge in the example shown in FIG. 7A) as an element of the problem which the user is facing, and determine which of the individual cases matches the problem of the user. Therefore, the determination is easier than in a case where the answer includes only text information. That is, the user need not struggle to make a determination or need not investigate additional information for determination, thereby reducing the user's labor.

On the other hand, as shown in FIG. 7B, if the question of the user and the answer to it do not focus on the appearance of the object, it is considered that important information as the answer can sufficiently be represented only by a character string, and the answer does not include an image as related non-text information. Thus, information for determining which of the individual cases matches the problem of the user is sufficiently included in the answer, and the viewability of the answer is improved, as compared with a case where an image is also described as an answer, thereby reducing the user's labor.

As described above, according to this embodiment, even if important information as an answer cannot be represented only by a character string, the user readily understands the contents of the answer by presenting non-text information that is important information as the answer, thereby reducing the user's labor.

### Modification 1 of First Embodiment

In the first embodiment, the decision unit 304 decides the presentation mode of an answer based on a question of a user and text information regarding the answer. However, a method of deciding the presentation mode of an answer is not limited to a specific one.

For example, the decision unit 304 may decide the presentation mode of an answer based on a question of a user and a preset template character string. In this case, for example, in step S601, the decision unit 304 generates, as a text prompt, a character string by combining the preset template character string and the question transmitted from the tablet 3. The template character string is, for example, “in the next question, please answer Yes or No to indicate whether the appearance of an object is focused on”.

Alternatively, the decision unit 304 may decide the presentation mode of an answer based on “the text information regarding the answer” generated by the generation unit 302 and the preset template character string. In this case, for example, in step S601, a character string is generated as a text prompt by combining the preset template character string and “the text information regarding the answer” generated by the generation unit 302. The template character string is, for example, “in the next answer, please answer Yes or No to indicate whether the appearance of an object is focused on”.

In a case where at least one of the question from the user and the text information of the answer is a long sentence, the computation cost of processing using the large language model by the decision unit 304 can be decreased by deciding the presentation mode of the answer using one of the question and the answer, which includes a smaller number of characters, and the preset template character string, as described above.

As described above, regardless of which of the above methods is used, it is possible to determine whether important information as an answer can be represented only by a character string, and to appropriately decide whether to include non-text information as the presentation mode of the answer.

### Modification 2 of First Embodiment

In the first embodiment, the decision unit 304 uses the large language model to decide the presentation mode of an answer. However, a method of deciding the presentation mode of an answer is not limited to a specific one.

For example, the presentation mode of an answer may be decided using a learned machine learning model instead of the large language model. As the algorithm of the machine learning model to be used, LSTM, BERT, or the like is considered. In this case, assumed questions and answers are prepared as inputs and the determination results of the presentation mode are prepared as outputs, thereby using them for learning of the machine learning model.

Alternatively, it may be determined whether an input sentence includes predetermined keywords. The predetermined keywords include, for example, “image”, “picture”, and “photo”. The determination may be performed by using the above-described determination methods in combination. By using the above-described method, the processing time can be shortened, as compared with a case where processing using the large language model is performed.

Note that regardless of which of the above methods is used, the decision unit 304 can determine whether important information as an answer can be represented only by a character string, and appropriately decide whether to include non-text information as the presentation mode of the answer.

### Modification 3 of First Embodiment

In the first embodiment, the decision unit 304 decides whether to present, an answer, an image that is non-text information by determining whether a question of a user and an answer to it focus on the appearance of an object, but the present disclosure is not limited to this. This modification will describe a method in which the decision unit 304 determines whether a question of a user and an answer to it focus on the fine appearance of an object and decides a presentation mode to change the resolution (display resolution) when displaying an image that is non-text information presented as the answer. This allows the user to more readily understand the contents of the presented answer.

The decision unit 304 determines whether each of a question of a user and text information regarding an answer includes predetermined keywords related to the fine appearance. The predetermined keywords include, for example, “dot”, “stripe”, and “fine”. If at least one of the question of the user and the text information regarding the answer includes the predetermined keywords related to the fine appearance, the decision unit 304 decides the presentation mode of non-text information to increase (for example, higher than a default display resolution) the display resolution of the non-text information (the image presented as the answer). On the other hand, if neither of the question of the user nor the text information regarding the answer includes the predetermined keywords related to the fine appearance, the decision unit 304 decides the presentation mode of the non-text information to decrease (for example, lower than the default display resolution) the display resolution of the non-text information (the image presented as the answer).

In this method, if at least one of the question of the user and the text information regarding the answer includes the predetermined keywords related to the fine appearance, it is considered that the fine appearance is important for determination by the user. Therefore, the tablet 3 displays an image at a higher resolution together with each individual case presented as the answer. Thus, the user can also focus on the fine portion of the presented image, and it becomes easy for the user to determine which of the individual cases should be focused on, thereby reducing labor.

On the other hand, if neither of the question of the user nor the text information regarding the answer includes the predetermined keywords related to the fine appearance, it is considered that the fine appearance is not important for determination by the user. Therefore, the tablet 3 displays an image at a relatively low resolution together with each individual case presented as the answer. This can reduce the data amount of the image presented as the answer, as compared with a case where the image is displayed at a high resolution, and can present the answer with a low delay, thereby reducing the answer waiting time of the user.

### Modification 4 of First Embodiment

In the first embodiment, the acquisition unit 303 acquires representative non-text information associated with a source location using the dictionary registered in the database 306, but a method of acquiring representative non-text information is not limited to a specific one.

For example, the acquisition unit 303 may acquire a piece of non-text information appearing first when counting from the beginning among pieces of non-text information associated with a source location (for example, pieces of non-text information linked in a source document (HTML document)).

If the source location indicates a portion of document data in the database 306, the acquisition unit 303 may acquire associated non-text information in the source location or closest non-text information in terms of the number of characters or the number of rows from the source location.

Alternatively, the acquisition unit 303 may calculate the similarity between the text information related to the source location and each of the pieces of non-text information, and then acquire the non-text information with the highest similarity. The text information related to the source location is, for example, the text information of the entire source document, or the character string of the title of the document data including the source location.

Alternatively, the acquisition unit 303 may calculate the similarity between the text information regarding the answer and each of the pieces of non-text information, and then acquire the non-text information with the highest similarity. As the similarity, for example, the cosine similarity between the embeddings converted using the multimodal model of the modalities (for example, images) of the non-text information and the language is used.

If there exists the heading of the non-text information, the acquisition unit 303 may calculate the similarity between the text information regarding the answer and the heading of each of the pieces of non-text information, and then acquire the non-text information with the highest similarity. As this similarity, for example, the cosine similarity between the embeddings obtained by converting the pieces of text information using the language model is used.

Regardless of which of the above methods is used, the acquisition unit 303 can appropriately acquire the non-text information to be presented as the answer to the question, thereby obtaining the same effect as in the first embodiment.

### Modification 5 of First Embodiment

The first embodiment has explained a case where non-text information is an image, but non-text information is not limited to an image. A case where non-text information is sound will be described below. Differences from the first embodiment will be described below.

For example, assume that in step S401, the question acquisition unit 301 acquires a question “abnormal noise from ABC unit, what are possible causes and remedies?”. In this case, in step S402, the generation unit 302 acquires text information regarding an answer using the question and a source document corresponding to the question, like the first embodiment. In step S403, the acquisition unit 303 acquires, as non-text information, audio (an audio file) associated with a source passage corresponding to the source location in the source document.

Then, the decision unit 304 generates a text prompt by performing the same processing as in step S601 using a template character string regarding sound (for example, “in the next question and answer, please answer Yes or No to indicate whether the sound is focused on”).

In step S602, the decision unit 304 inputs the text prompt generated in step S601 to the large language model 307 and performs inference using the large language model 307, thereby acquiring “Yes” or “No” as an answer corresponding to the text prompt. That is, the decision unit 304 determines, based on the text prompt, whether the question and answer focus on the sound.

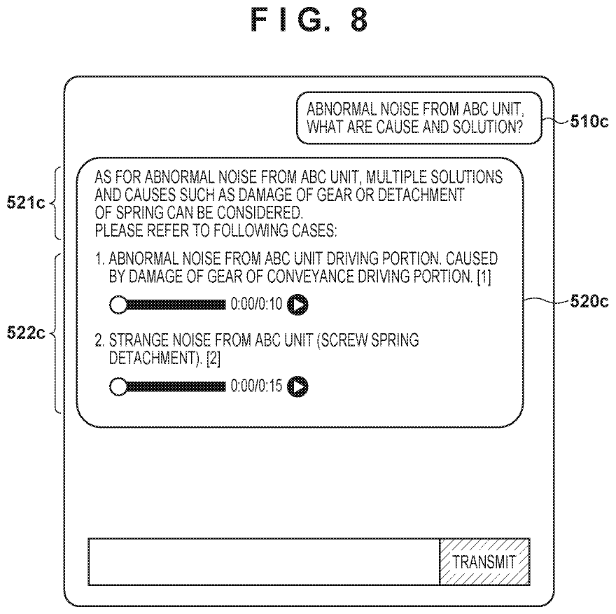

In step S405, the presentation unit 305 presents the answer to the question to the user via the presentation device 104 in accordance with the presentation mode decided by the decision unit 304. FIG. 8 is a view showing a display example of an answer screen that is displayed on the presentation device 104 by the presentation unit 305 when the decision unit 304 decides “to present an answer including non-text information” as “the presentation mode of the answer”.

In this case, the presentation unit 305 receives “the text information regarding the answer” and “the non-text information” transmitted from the question answering system 4, generates an answer screen including the received “text information regarding the answer” and an interface for playing back the received “non-text information”, and causes the presentation device 104 to display the answer screen.

On the answer screen shown in FIG. 8, a user-side chat bubble 510c representing a question input by a user and a system-side chat bubble 520c representing an answer to the question are displayed. The system-side chat bubble 520c includes a beginning portion 521c and an individual case portion 522c. Each individual case included in the individual case portion 522c includes a sentence related to source contents described in a source passage in the source document identified by the source location found in the database 306 by the generation unit 302, and an interface for playing back corresponding non-text information. Text information and an interface in the system-side chat bubble 520c correspond to “the text information regarding the answer” and “the interface for playing back the non-text information”, respectively.

When the user inputs a playback instruction of the non-text information by operating the interface using the input device 103, the presentation unit 305 plays back the non-text information, and outputs the corresponding sound via the sound output device of the presentation device 104, such as a loudspeaker or headphones.

As described above, if the question of the user and the answer to it focus on the sound and important information as the answer may not be represented only by a character string, the answer including the related sound is presented.

By the above method, in a case where the sound is important information as the answer, the user can listen to the sound related to the answer, and thus the u ser need not struggle to make a determination or need not investigate additional information for determination, thereby reducing the user's labor.

### Modification 6 of First Embodiment

A case where non-text information is a moving image will be described below. Differences from the first embodiment will be described below. For example, assume that in step S401, the question acquisition unit 301 acquires a question “how to replace ABC unit?”. In this case, in step S402, the generation unit 302 acquires text information regarding an answer using the question and a source document corresponding to the question, like the first embodiment. In step S403, the acquisition unit 303 acquires, as non-text information, a moving image (moving image file) associated with the source location of the source document.

Then, the decision unit 304 generates a text prompt by performing the same processing as in step S601 using a template character string regarding the moving image (for example, “in the next question and answer, please answer Yes or No to indicate whether there should be the moving image for supporting the answer”) as a template character string.

In step S602, the decision unit 304 inputs the text prompt generated in step S601 to the large language model 307 and performs inference using the large language model 307, thereby acquiring “Yes” or “No” as an answer corresponding to the text prompt. That is, the decision unit 304 determines, based on the text prompt, whether the question and answer focus on the moving image.

In step S405, the presentation unit 305 presents the answer to the question to the user via the presentation device 104 in accordance with the presentation mode decided by the decision unit 304. An answer screen that is displayed on the presentation device 104 by the presentation unit 305 when the decision unit 304 decides “to present an answer including the non-text information” as “the presentation mode of the answer” is the same as that shown in FIG. 7A except that the moving image and an interface for reproducing the moving image are displayed instead of the image.

When the user inputs a reproduction instruction of the moving image by operating the interface using the input device 103, the presentation unit 305 reproduces the moving image and displays it on the answer screen on the presentation device 104.

As described above, if the question of the user and the answer to it focus on the moving image and important information as the answer may not be represented only by a character string, the answer including the related moving image is presented. Thus, the user need not struggle to make a determination or need not investigate additional information for determination, thereby reducing the user's labor.

Note that in a case where non-text information is a moving image, the decision unit 304 may use, as a template character string used to generate a text prompt, a template character string “in the next question and answer, please answer Yes or No to indicate whether only a thumbnail image in the moving image for supporting the answer is sufficient”. In this case, the acquisition unit 303 may acquire, as non-text information, the thumbnail image of an image of an arbitrary one frame in the acquired moving image. This can display only the image, like the first embodiment, thereby concisely providing the answer.

Similarly, as a template character string used to create a text prompt, a template character string “in the next question and answer, please answer Yes or No to indicate whether only sound information in the moving image for supporting the answer is sufficient” may be used. In this case, the acquisition unit 303 may acquire sound in the moving image as non-text information. This can present an answer including the sound, like Modification 5 of the first embodiment, thereby concisely providing the answer to the user.

### Modification 7 of First Embodiment

In the first embodiment, the question acquisition unit 301 acquires the question input to the input box 501 on the screen 500 by the user using the input device 103, but a method of acquiring a question is not limited to a specific one. For example, the question acquisition unit 301 may acquire a voice uttered by the user via a microphone provided in the input device 103, and acquire, as a question, a character string obtained by transcribing the acquired voice. In this method as well, the same effect as in the first embodiment can be obtained.

### Modification 8 of First Embodiment

In the first embodiment, to generate text information regarding an answer, the generation unit 302 uses the method described in P. Lewis et al., “Retrieval-Augmented Generation for Knowledge-Intensive NLP Tasks,” Advances in Neural Information Processing Systems, vol. 33, pp. 9459-9474, 2020. However, a method of generating text information regarding an answer is not limited to a specific one.

For example, the generation unit 302 generates a text prompt using a question of a user acquired by the question acquisition unit 301 (without using text information in the database 306). Then, the generation unit 302 inputs the generated text prompt to the large language model and performs inference using the large language model, thereby generating, as text information regarding an answer, an output corresponding to the text prompt.

In this case, the generation unit 302 does not acquire the information of the source location in the database 306 necessary for the acquisition unit 303 to acquire non-text information in the first embodiment. Therefore, the acquisition unit 303 needs to additionally search the database 306 based on the question of the user and the text information regarding the answer generated by the generation unit 302 to acquire non-text information related to the question and the answer.

In a case where the text information in the database 306 is unnecessary as the answer to the question of the user, the above method can be used to reduce the processing time required to acquire the data in the database 306 and suppress deterioration in accuracy of the answer caused by inputting unnecessary data in the database 306 to the large language model. In this method as well, the same effect as in the first embodiment can be obtained.

### Second Embodiment

In the following embodiments and modifications including this embodiment, differences from the first embodiment will be described, and the rest is the same as in the first embodiment unless it is specifically stated otherwise.

In the first embodiment, the decision unit 304 decides the presentation mode of an answer based on the importance of non-text information in the contents of the answer to be presented. In this embodiment, a decision unit 304 decides the presentation mode of an answer including the presentation mode of non-text information from the viewpoint of whether the answer to be presented is easily viewable.

In this embodiment, processing performed by a tablet 3 and a question answering system 4 to create an answer to a question input by a user and present it to the user is the same as in the first embodiment except for processing in step S404 in the flowchart of FIG. 4. The processing in step S404 according to this embodiment will be described below.

The decision unit 304 counts the number of characters in text information regarding an answer generated by a generation unit 302. Then, if the counted number of characters is smaller than a threshold, the decision unit 304 decides the presentation mode of non-text information so as to present, in a larger display size (for example, a display size larger than a default display size), an image that is non-text information to be presented as an answer. On the other hand, if the counted number of characters is equal to or larger than the threshold, the decision unit 304 decides the presentation mode of non-text information so as to present, in a smaller display size (for example, a display size smaller than the default display size), an image that is non-text information to be presented as an answer.

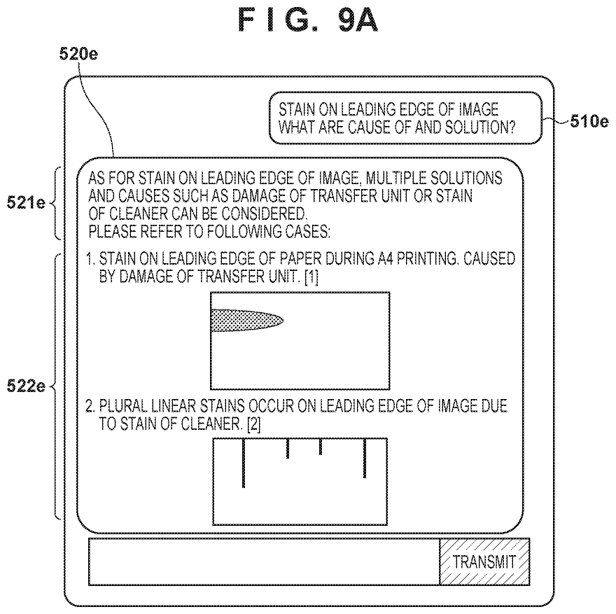

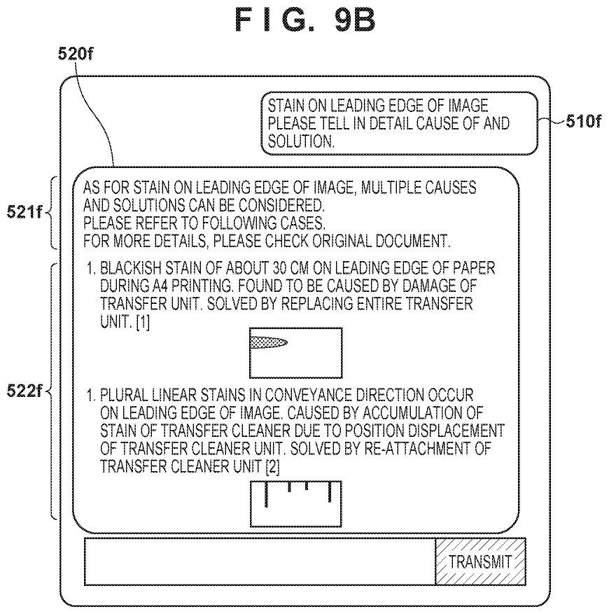

Thus, in step S405, the tablet 3 displays the non-text information in the display size corresponding to the presentation mode of the non-text information. The answer presented in accordance with the presentation mode decided by the decision unit 304 (the answer presented by a presentation unit 305 in step S405) will be described with reference to FIGS. 9A and 9B.

FIG. 9A is a view showing a display example of an answer screen that is displayed on a presentation device 104 by the presentation unit 305 when the decision unit 304 decides “to present an image that is non-text information in a larger display size”.

On the answer screen shown in FIG. 9A, a user-side chat bubble 510e representing a question input by a user and a system-side chat bubble 520e representing an answer to the question are displayed. The system-side chat bubble 520e includes a beginning portion 521e and an individual case portion 522e. Each individual case included in the individual case portion 522e includes a sentence related to source contents described in a source document identified by a source location found in a database 306 by the generation unit 302 and corresponding non-text information. Text information and an image in the system-side chat bubble 520e correspond to “the text information regarding the answer” and “the non-text information”, respectively.

In FIG. 9A, since the presentation mode of the non-text information is decided “to present an image that is non-text information in a larger display size”, the image that is the non-text information is displayed in a larger display size on the presentation device 104. As shown in FIG. 9A, if the number of characters in the answer is small, the characters in the answer and the image are easily viewable by increasing the display size of the image.

FIG. 9B is a view showing a display example of an answer screen that is displayed on the presentation device 104 by the presentation unit 305 when the decision unit 304 decides “to present an image that is non-text information in a smaller size”.

On the answer screen shown in FIG. 9B, a user-side chat bubble 510f representing a question input by a user and a system-side chat bubble 520f representing an answer to the question are displayed. The system-side chat bubble 520f includes a beginning portion 521f and an individual case portion 522f. Each individual case included in the individual case portion 522f includes a sentence related to source contents described in a source document identified by a source location found in the database 306 by the generation unit 302 and corresponding non-text information. Text information and an image in the system-side chat bubble 520f correspond to “the text information regarding the answer” and “the non-text information”, respectively.

In FIG. 9B, since the presentation mode of the non-text information is decided “to present an image that is non-text information in a smaller display size”, the image that is the non-text information is displayed in a smaller display size on the presentation device 104. As shown in FIG. 9B, if the number of characters in the answer is large, the viewability of the entire answer is improved by decreasing the display size of the image, thereby maintaining a state in which the answer is easily viewable. When the number of characters in the answer is large, if the display size of the image is large, the entire answer largely extends from the screen, and it is difficult to visually recognize the entire answer, thereby taking time for the user to make determination based on the answer while scrolling the screen. In this embodiment, it is possible to reduce the labor.

In the method according to this embodiment, by changing, in accordance with the number of characters in an answer to a question, the display size of an image that is non-text information to be presented together, it is possible to present the answer while maintaining the visibility for the user.

### Modification 1 of Second Embodiment

In this modification, in accordance with the number of individual cases in the individual case portion 522 of the text information of the answer generated by the generation unit 302, the decision unit 304 decides whether to present non-text information as the answer.

For example, the decision unit 304 decides, as the presentation mode of non-text information, not to present non-text information as the answer in a case where the number of individual cases is equal to or larger than a threshold (for example, 1 0) and to present non-text information in a case where the number of individual cases is smaller than the threshold.

As described above, in a case where the number of individual cases is large, if non-text information is listed together, it is difficult for the user to visually recognize the answer, and thus the non-text information is not presented. Thus, only the text information is presented to maintain visibility for the user, thereby making it possible to reduce the user's labor for determination. Note that the present disclosure is not limited to this, and in a case where the number of individual cases is equal to or larger than the threshold (for example, 10), pieces of non-text information, the number of which is up to the threshold, may be presented.

### Modification 2 of Second Embodiment

In the second embodiment, in accordance with the number of characters in an answer to a question, the display size of an image that is non-text information in the answer is changed. However, the display size of an image that is non-text information to be presented as an answer may be changed in accordance with the number of acquired pieces of non-text information.

For example, in a case where the number of acquired pieces of non-text information is equal to or larger than a threshold (for example, four), the decision unit 304 decides, as the presentation mode of the non-text information, “to display an image that is non-text information in a smaller display size”. On the other hand, in a case where the number of acquired pieces of non-text information is smaller than the threshold, the decision unit 304 decides, as the presentation mode of the non-text information, “to display an image that is non-text information in a larger display size”.

Thus, in a case where the number of acquired pieces of non-text information is large, if the pieces of non-text information are listed in a large display size, it is difficult for the user to visually recognize the answer. Therefore, by presenting the pieces of non-text information in a small display size, it is possible to maintain the visibility of the entire answer for the user and reduce the user's labor for determination.

### Third Embodiment

In this embodiment, in a case where there are a plurality of cases presented as an answer, the presentation mode of the answer including the presentation mode of non-text information is decided from the viewpoint of whether it is easy to identify the individual cases.

In this embodiment, processing performed by a tablet 3 and a question answering system 4 to create an answer to a question input by a user and present it to the user is the same as in the first embodiment except for processing in step S404 in the flowchart of FIG. 4. The processing in step S404 according to this embodiment will be described below.

A decision unit 304 acquires, for each individual case, text information regarding the individual case in text information regarding an answer generated by a generation unit 302, and obtains the similarity between the acquired pieces of text information of the individual cases. A method of obtaining the similarity between the pieces of text information of the individual cases is not limited to a specific one. For example, the decision unit 304 acquires the cosine similarity between embeddings obtained by inputting the pieces of text information of the individual cases to a language model and performing inference using the language model.

Then, if a highest one of the obtained similarities is equal to or higher than a threshold (for example, 0.8), the decision unit 304 decides the presentation mode to present, as the answer, an image that is non-text information. On the other hand, if the highest similarity is lower than the threshold, the decision unit 304 decides the presentation mode not to present, as the answer, an image that is non-text information.

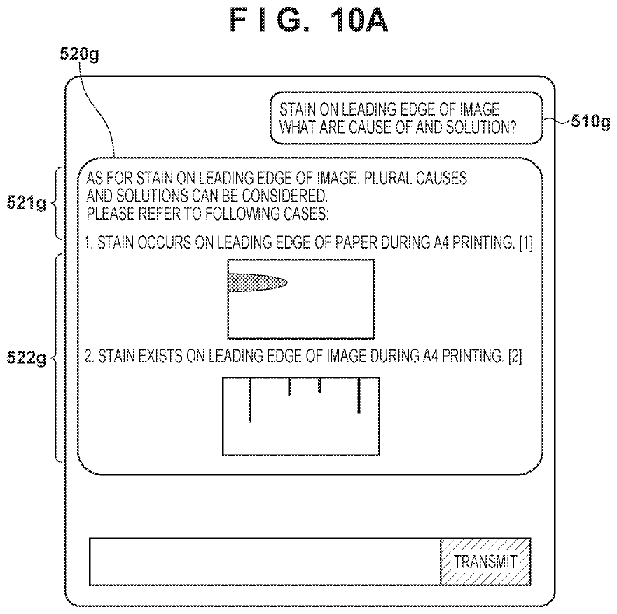

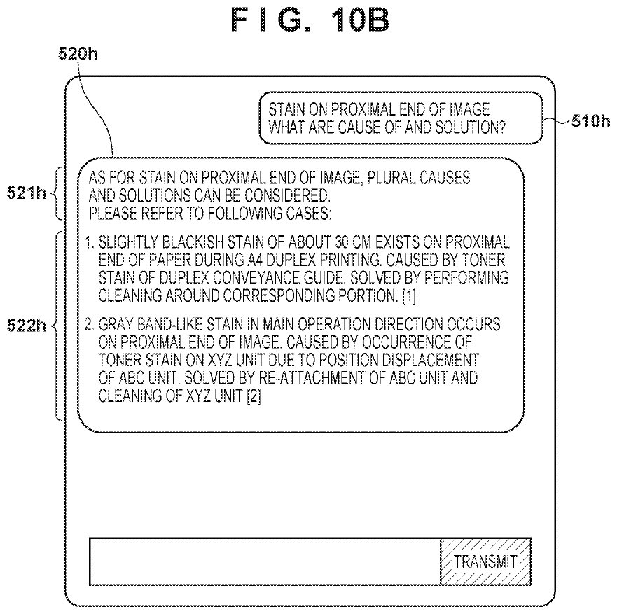

The answer presented in accordance with the presentation mode decided by the decision unit 304 (the answer presented by a presentation unit 305 in step S405) will be described with reference to FIGS. 10A and 10B. FIG. 10A is a view showing a display example of an answer screen that is displayed on a presentation device 104 by the presentation unit 305 when the decision unit 304 decides “to present an answer including non-text information” as “the presentation mode of the answer”.

On the answer screen shown in FIG. 10A, a user-side chat bubble 510g representing a question input by a user and a system-side chat bubble 520g representing an answer to the question are displayed. The system-side chat bubble 520g includes a beginning portion 521g and an individual case portion 522g. Each individual case included in the individual case portion 522g includes a sentence related to source contents described in a source document identified by a source location found in a database 306 by the generation unit 302 and corresponding non-text information. Text information and an image in the system-side chat bubble 520g correspond to “the text information regarding the answer” and “the non-text information”, respectively.

FIG. 10B is a view showing a display example of an answer screen that is displayed on the presentation device 104 by the presentation unit 305 when the decision unit 304 decides “to present an answer without non-text information” as “the presentation mode of the answer”.

On the answer screen shown in FIG. 10B, a user-side chat bubble 510h representing a question input by a user and a system-side chat bubble 520h representing an answer to the question are displayed. The system-side chat bubble 520h includes a beginning portion 521h and an individual case portion 522h. Each individual case included in the individual case portion 522h includes a sentence related to source contents described in a source document identified by a source location found in the database 306 by the generation unit 302 but includes no corresponding non-text information unlike FIG. 10A. Text information in the system-side chat bubble 520h corresponds to “the text information regarding the answer”.

As shown in FIG. 10A, if the similarity between the pieces of text information of the individual cases is high, when images that are pieces of non-text information are presented, the user can identify which of the individual cases is a desired one by confirming the images although it is difficult to identify it only based on the pieces of text information. On the other hand, as shown in FIG. 10B, if the similarity between the pieces of text information of the individual cases is low, the user can identify which of the individual cases is a desired one only based on the pieces of text information without presenting the images. In this case, by not presenting the images, it is possible to maintain the visibility of the entire answer.

According to this embodiment, in accordance with the similarity between the pieces of text information of individual cases in an answer, it is decided whether to present non-text information as an answer, thereby presenting the answer while maintaining identifiability between the individual cases in the answer.

### Modification 1 of Third Embodiment

In this modification, in accordance with the similarity between pieces of non-text information, the sizes of images that are pieces of non-text information to be presented as an answer are changed. For example, the decision unit 304 obtains the similarity between pieces of non-text information acquired by an acquisition unit 303. Regardless of whether the non-text information is an image or sound, a method of obtaining the similarity between the images or the similarity between the sounds is known, and a method of obtaining the similarity between pieces of non-text information is not limited to a specific one in this embodiment.

Then, if a highest one of the obtained similarities is equal to or higher than a threshold (for example, 0.8), the decision unit 304 decides the presentation mode of the non-text information to present, in a larger display size (for example, a display size larger than a default display size), the images that are the pieces of non-text information to be presented as an answer. On the other hand, if the highest one of the obtained similarities is lower than the threshold, the decision unit 304 decides the presentation mode of the non-text information to present, in a smaller display size (for example, a display size smaller than the default display size), the images that are the pieces of non-text information to be presented as an answer. Thus, in step S405, the tablet 3 displays the pieces of non-text information in the display size according to the presentation mode of the non-text information.

Therefore, in a case where the similarity between the images that are the pieces of non-text information is high, if the sizes of the presented images are small, it may be difficult for the user to identify them, and thus it is possible to maintain the identifiability for the user by increasing the sizes of the presented images.

### Fourth Embodiment

In the first to third embodiments, the decision unit 304 decides the presentation mode of an answer from different viewpoints. In this embodiment, the presentation mode of an answer is decided based on all the viewpoints of the decision unit 304 according to the first to third embodiments. A decision unit 304 obtains a determination score (0 to 1) using a machine learning model from each of the viewpoints of the decision unit 304 according to the first to third embodiments.

For example, the decision unit 304 acquires, as a first determination score corresponding to the viewpoint of the decision unit 304 of the first embodiment, a score obtained by inputting, to a machine learning model, a likelihood output from a large language model 307 as the likelihood of the answer acquired in step S602 of the first embodiment and performing inference using the machine learning model.

The decision unit 304 acquires, as a second determination score corresponding to the viewpoint of the decision unit 304 of the second embodiment, a score obtained by inputting, to a machine learning model, the number of characters in text information regarding an answer generated by a generation unit 302 and performing inference using the machine learning model.

The decision unit 304 acquires, as a third determination score corresponding to the viewpoint of the decision unit 304 of the third embodiment, a score obtained by inputting the highest similarity to a machine learning model and performing inference using the machine learning model.

Then, the decision unit 304 obtains, as a total determination score, the total sum or weighted linear sum of the first determination score, the second determination score, and the third determination score. If the total determination score is equal to or larger than a threshold (for example, 0.8), the decision unit 304 decides to present non-text information as an answer, and if the total determination score is smaller than the threshold, the decision unit 304 decides not to present non-text information as an answer.

Furthermore, the decision unit 304 may generate a text prompt by combining a question from a user, text information regarding an answer generated by the generation unit 302, and a character string indicating that determination is performed from the viewpoints of the decision unit 304 according to the first to third embodiments. In this case, the decision unit 304 acquires a presentation mode of whether to present non-text information by inputting the text prompt to the large language model and performing inference using the large language model.

The above method can appropriately decide whether to present non-text information from all of the viewpoints of “whether the user readily understands the contents of an answer to be presented”, “whether the user can readily visually recognize an answer to be presented”, and “whether it is easy to identify individual cases to be presented as an answer”, thereby reducing the user's labor for determining whether the answer is a desired one.

### Fifth Embodiment

The use scenes of the system used in the above description of the embodiments and modifications are merely examples of troubleshooting, and the above system can be applied to other troubleshooting scenes. The use scene of the system is not limited to troubleshooting.

A tablet 3 and a question answering system 4 may exist at a location different from that of a broken printer 1, for example, on a maintenance company side. That is, as the arrangement of the tablet 3 and the question answering system 4, various arrangements are considered in accordance with the system application case and the like.

The above embodiments and modifications have explained a case where th tablet 3 and the question answering system 4 are separate apparatuses. The present disclosure is not limited to this, and for example, an information processing apparatus integrating the tablet 3 and the question answering system 4 may be formed. In this case, this information processing apparatus executes or controls various kinds of processing (except for communication processing between the apparatuses) described as processing executed by each of the tablet 3 and the question answering system 4.

The above embodiments and modifications have explained a case where th tablet 3 includes the question acquisition unit 301 and the presentation unit 305 and the question answering system 4 includes the generation unit 302, the acquisition unit 303, the decision unit 304, the database 306, and the large language model 307. However, the present disclosure is not limited to this. For example, the tablet 3 may include the decision unit 304. The database 306 and the large language model 307 may be provided in the tablet 3. In addition, one or more of the function units shown in FIG. 3 may be implemented by hardware.

Numerical values, processing timings, processing orders, main constituents of processing, data (information) configurations/acquisition methods/transmission destinations/transmission sources/storage locations, and the like used in the above-described embodiments are mere examples used to make a detailed description, and are not intended to be limited to the examples.

Some or all of the above-described embodiments may appropriately be used in combination. In addition, some or all of the above-described embodiments may selectively be used.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2025-060707, filed Apr. 1, 2025, which is hereby incorporated by reference herein in its entirety.

What is claimed is:

1. An information processing apparatus comprising:
an acquisition unit configured to acquire, based on an input question, text information regarding an answer to the question using a large language model;
a decision unit configured to decide, based on the text information, whether to present non-text information; and
a transmission unit configured to transmit the text information and the non-text information in a case where it is decided to present the non-text information, and transmit the text information in a case where it is decided not to present the non-text information.

2. The apparatus according to claim 1, wherein the acquisition unit acquires, based on the question and a dictionary registered in a database corresponding to the question, the text information regarding the answer to the question.

3. The apparatus according to claim 1, wherein the decision unit acquires the non-text information based on the question and the text information.

4. The apparatus according to claim 1, wherein the decision unit generates a text prompt including the question and/or the text information, and decides, based on the text prompt, whether to present the non-text information.

5. The apparatus according to claim 1, wherein the decision unit generates a text prompt including one of the question and the text information, which includes a smaller number of characters, and decides, based on the text prompt, whether to present the non-text information.

6. The apparatus according to claim 1, wherein the decision unit decides, based on the number of individual cases in the text information, whether to present the non-text information.

7. The apparatus according to claim 1, wherein the decision unit decides, based on similarity between pieces of text information of individual cases in the text information, whether to present the non-text information.

8. The apparatus according to claim 1, wherein the decision unit decides a display resolution of the non-text information in accordance with whether the question and/or the text information includes a keyword related to a fine appearance.

9. The apparatus according to claim 1, wherein the decision unit decides a display size of the non-text information in accordance with the number of characters in the text information.

10. The apparatus according to claim 1, wherein the decision unit decides a display size of the non-text information based on the number of pieces of non-text information.

11. The apparatus according to claim 1, wherein the decision unit decides a display size of the non-text information based on a similarity between the pieces of non-text information.

12. The apparatus according to claim 1, wherein the non-text information includes one of an image, sound, a moving image, a thumbnail image of an image of one frame in a moving image, and sound in a moving image.

13. An information processing apparatus comprising:
an acquisition unit configured to acquire, based on an input question, text information regarding an answer to the question using a large language model;
a decision unit configured to decide, based on the text information, whether to present non-text information; and
a presentation unit configured to present the text information and the non-text information in a case where it is decided to present the non-text information, and present the text information in a case where it is decided not to present the non-text information.

14. An information processing method executed by an information processing apparatus, comprising:
acquiring, based on an input question, text information regarding an answer to the question using a large language model;
deciding, based on the text information, whether to present non-text information; and
transmitting the text information and the non-text information in a case where it is decided to present the non-text information, and transmitting the text information in a case where it is decided not to present the non-text information.

15. An information processing method executed by an information processing apparatus, comprising:
acquiring, based on an input question, text information regarding an answer to the question using a large language model;
deciding, based on the text information, whether to present non-text information; and
presenting the text information and the non-text information in a case where it is decided to present the non-text information, and presenting the text information in a case where it is decided not to present the non-text information.

16. A non-transitory computer-readable storage medium storing a computer program for causing a computer to:
acquire, based on an input question, text information regarding an answer to the question using a large language model;
decide, based on the text information, whether to present non-text information; and
transmit the text information and the non-text information in a case where it is decided to present the non-text information, and transmit the text information in a case where it is decided not to present the non-text information.

17. A non-transitory computer-readable storage medium storing a computer program for causing a computer to:
acquire, based on an input question, text information regarding an answer to the question using a large language model;
decide, based on the text information, whether to present non-text information; and
present the text information and the non-text information in a case where it is decided to present the non-text information, and present the text information in a case where it is decided not to present the non-text information.
